(19) United States
(12) Patent Application Publication
(10) Pub. No.: US 2022/0253841 A1
(43) Pub. Date: Aug. 11, 2022

(54) METHOD FOR PROVIDING NEUTRAL HOST NETWORK SERVICE BY USING BLOCKCHAIN, AND SYSTEM AND DEVICE THEREFOR

(71) Applicant: HFR, INC., Seongnam-si, Gyeonggi-do (KR)

(72) Inventor: Jong Heon LEE, Seongnam-si (KR)

(73) Assignee: HFR, INC., Seongnam-si, Gyeonggi-do (KR)

(21) Appl. No.: 17/430,841

(22) PCT Filed: May 16, 2019
(86) PCT No.: PCT/KR2019/005861

§ 371 Date: Apr. 11, 2022

(30) Foreign Application Priority Data
Jan. 8, 2019 (KR) 10-2019-0002204
May 9, 2019 (KR) 10-2019-0054130

(51) Int. Cl. G06Q 20/38; H04L 41/5009

(52) U.S. Cl. CPC G06Q 20/3825; G06Q 2220/00; H04L 41/5009

(57) ABSTRACT

The present disclosure in some embodiments relates to a method of providing a neutral host network service, and a system and a device therefor, the method using a blockchain and a smart contract to efficiently process complicated agreements and fulfillment management between telecommunication service providers, such as those for reducing transaction costs including trust-building, setting reasonable service rates according to quality and their settlement, and compensation based on an SLA.

### TECHNICAL FIELD

The present disclosure in some embodiments relates to utilizing a blockchain in providing a neutral host network service. More particularly, the present disclosure relates to a method, a system, and an apparatus for providing a neutral host network service for efficiently handling complicated agreements and fulfillment management between mobile network operators and neutral host network operators by using a blockchain and a smart contract.

### BACKGROUND

The statements in this section merely provide background information related to the present disclosure and do not necessarily constitute prior art.

With the evolution of mobile communication services, innovative revolutions are expected in the business composition among telecommunication service providers toward increased frequency usage efficiency, reduced costs of network establishment and operation, and promptly introducing and optimizing various services. In tandem with the existing unlicensed bands, various types of spectrum sharing systems are expected to come to a realization and herald a large number of small local mobile network operators to appear.

In particular, attention is focused on a neutral host network service model that provides a local network service through an agreement with a mobile network operator having subscribers. The telecommunication industry predicts the introduction and proliferation of private mobile communication networks using an unlicensed or shared spectrum along with a viable service business model of sharing idle resources of the private networks with external users.

FIG. 1 is a conceptual diagram for explaining the structure of a conventional neutral host network service model.

In FIG. 1, neutral host network service providers (hereinafter, neutral host operators, NHOs) each establish a local LTE and/or Wi-Fi network infrastructure using a shared frequency band and an unlicensed band and provide wireless network services to subscribers of mobile network operators (MNOs), for which the MNOs pay the NHOs.

By way of the conventional neutral host network service model, when n MNOs and m NHOs exist, up to n×m service agreements are required, which takes a lot of time and money. Additionally, a complicated procedure is required to confirm and compensate for violation of the guarantee and agreement on the service quality, leaving a high concern over disputes.

Although an efficient cooperative system needs to be established between operators for providing uninterrupted mobile communication services through interconnections of a large number of independent regional networks and national networks, no specific solution has been announced yet. Accordingly, it is necessary to implement an efficient cooperative platform between telecommunication service providers, addressing matters such as reducing transaction costs including trust-building, setting reasonable service rates according to quality and their settlement, and compensation based on a service level agreement (SLA).

### DISCLOSURE

### Technical Problem

The present disclosure in some embodiments seeks to provide a cooperative platform using a blockchain and a smart contract for efficiently handling complicated agreements and fulfillment management between telecommunication service providers, such as those for reducing transaction costs including trust-building, setting reasonable service rates according to quality and their settlement, and compensation based on an SLA.

### Technical Solution

At least one aspect of the present disclosure provides a neutral host network service system including a business platform, a neutral host network operator (NHO) node, and a mobile network operator (MNO) node. The business platform is configured to generate and store on a blockchain a smart contract related to a neutral host network service between an MNO and a NHO, and to perform a function for automatically executing the smart contract by using the blockchain. The NHO node is configured to identify a mobile user or user equipment (UE) subject to the neutral host network service under the smart contract, to provide the UE with the neutral host network service, and to collect service usage information on the neutral host network service as used by the UE. The MNO node is configured to pay a fee commensurate with the service usage information to the NHO node based on the blockchain and the smart contract.

Another aspect of the present disclosure provides a business platform including (i) a business service unit configured to generate and store on a blockchain a smart contract related to a neutral host network service between an MNO and a NHO, and (ii) a blockchain service unit configured to use the blockchain to perform a function for causing the smart contract to be automatically executed in relation to usage of the neutral host network service by a UE subject to the neutral host network service.

Yet another aspect of the present disclosure provides a method performed by a neutral host network service system for providing a service, the method including the steps (not necessarily in the following order) of (i) generating and storing, by a business platform, on a blockchain a smart contract related to a neutral host network service between an MNO and a NHO, (ii) identifying by an NHO node, a UE existing in a neutral host network coverage and subject to the neutral host network service under the smart contract and providing the UE with the neutral host network service, and (iii) collecting, by the NHO node, service usage information on the neutral host network service as used by the UE, delivering the service usage information to an MNO node, and paying, by the MNO node, a fee commensurate with the service usage information to the NHO node based on the blockchain and the smart contract.

Yet another aspect of the present disclosure provides a computer program recorded on a computer-readable medium and including codes for causing, when executed in at least one processor, the processor to perform steps (not necessarily in the following order) of (i) generating and storing, by a business platform, on a blockchain, a smart contract related to a neutral host network service between an MNO and a NHO, (ii) identifying by an NHO node, a UE existing in a neutral host network coverage and subject to the neutral host network service under the smart contract and providing the UE with the neutral host network service, and (iii) collecting, by the NHO node, service usage information on the neutral host network service as used by the UE, delivering the service usage information to an MNO node, and paying, by the MNO node, a fee commensurate with the service usage information to the NHO node based on the blockchain and the smart contract.

### Advantageous Effects

Embodiments of the present disclosure can provide a cooperative platform using a blockchain and a smart contract for efficiently handling complex agreements and fulfillment management between telecommunication service providers, such as reducing transaction costs including trust building, setting reasonable service rates according to quality and their settlement, and compensation based on an SLA.

### BRIEF DESCRIPTION OF THE DRAWINGS

FIG. 1 is a conceptual diagram for explaining the structure of a conventional neutral host network service model.

FIG. 2 is a conceptual diagram for explaining a neutral host network service system according to at least one embodiment of the present disclosure.

FIG. 3 is a conceptual diagram for explaining the structure of a blockchain network according to at least one embodiment of the present disclosure.

FIG. 4 is a block diagram illustrating a business platform according to at least one embodiment of the present disclosure.

FIG. 5 is a flowchart of a method of providing a neutral host network service according to at least one embodiment of the present disclosure.

FIG. 6 is a diagram illustrating a neutral host network service provision scenario according to at least one embodiment of the present disclosure.

FIGS. 7 to 12 are conceptual diagrams for explaining a neutral host network service provision scenario according to at least one embodiment of the present disclosure.

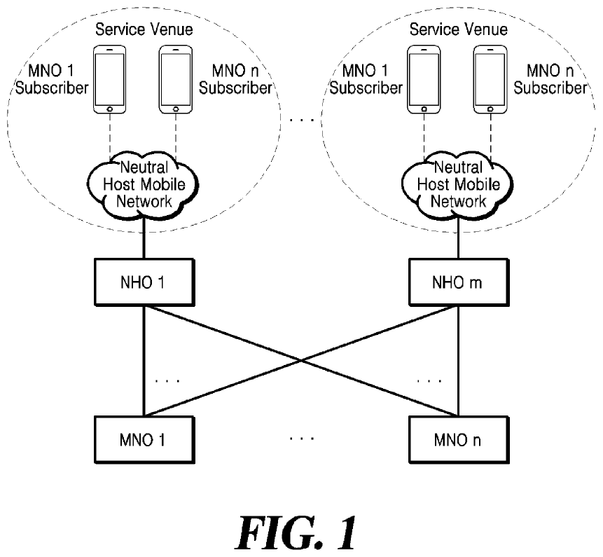

### DETAILED DESCRIPTION

Hereinafter, some embodiments of the present disclosure will be described in detail with reference to the accompanying drawings.

A blockchain is an electronic ledger implemented by a computer-based distributed system composed of blocks each made up of transactions. Each transaction includes at least one input and at least one output. The blocks are linked together so that the relevant blocks, each containing the hash of the previous block, generate a permanent and immutable record of all transactions written to the blockchain from the beginning.

A smart contract is a computer program designed to automate the execution of the terms of a contract or agreement. Unlike traditional contracts written in natural language, smart contracts are machine-executable programs that contain rules that can process inputs to produce results, from which actions can be triggered to be performed.

The present disclosure presents a method of providing a neutral host network service using such a blockchain and a smart contract. In more detail, the present disclosure provides a neutral host network service structure using a blockchain and a smart contract for efficiently handling complex agreements and fulfillment management between telecommunication service providers, such as reducing transaction costs including trust-building, setting reasonable service rates commensurate with quality and their settlement, and compensation based on an SLA (service level agreement).

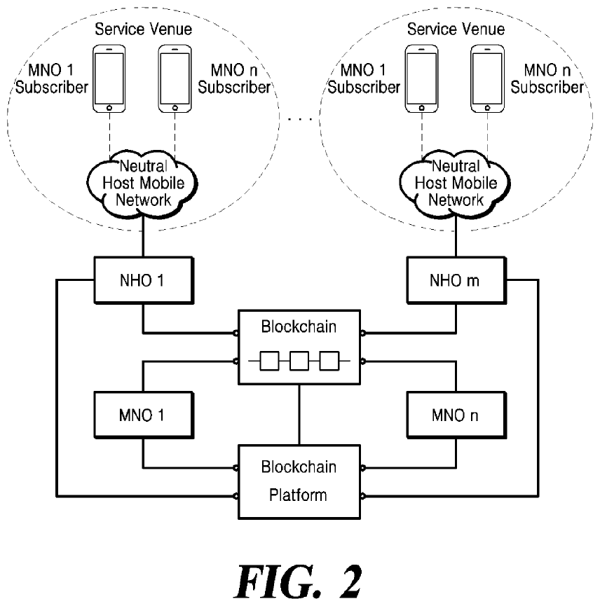

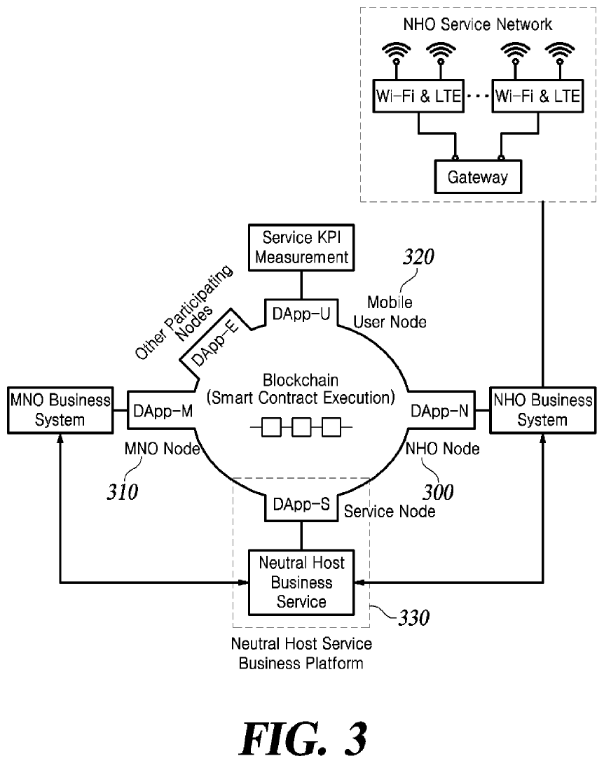

FIG. 2 is a conceptual diagram for explaining a neutral host network service system according to at least one embodiment of the present disclosure and FIG. 3 is a conceptual diagram for explaining a blockchain network structure of a neutral host network service system according to at least one embodiment of the present disclosure.

The following describes the neutral host network service system according to at least one embodiment of the present disclosure referring to FIGS. 2 and 3 together.

As shown in FIG. 2, the neutral host network service system according to at least one embodiment is implemented by the structure of the conventional neutral host network service model that is applied with the structure of the blockchain network of FIG. 3. This neutral host network service system uses the blockchain and smart contract to ensure efficient business agreements and fulfillment management in relation to neutral host network services, while also supporting and ensuring the reliability of transactions that occur during the service process.

The neutral host network service system according to at least one embodiment includes an NHO node (neutral host network operator node) 300, an MNO node (mobile network operator node) 310, a mobile user node or user equipment node 320, and a business platform 330, which constitute a blockchain network. In this case, components included in the neutral host network service system according to at least one embodiment of the present disclosure are not necessarily limited to these particulars. For example, in neutral host network service systems, it should be recognized that varying types of services may decide the types of nodes constituting the blockchain network with appropriate configurations of more or fewer components or different components than those as illustrated. In particular, although not shown in FIG. 3, nodes constituting the blockchain network according to some embodiments of the present disclosure include those related to utility tokens, stable coins, security tokens, and the like.

Meanwhile, in at least one embodiment, the respective nodes constituting the blockchain network of the neutral host network service system are implemented by a program in a computing device. For example, each node may be implemented by a Decentralized Application (DApp) which is a kind of decentralized software application in the computing device.

With such a DApp, the present disclosure provides a function that allows participants to see the ledger in the blockchain, input necessary data, and transmit and receive tokens, etc. Additionally, the present disclosure can provide various functions that enable support of effective services that provide convenience and efficiency in businesses using a blockchain.

The NHO node 300 is a blockchain network node corresponding to a neutral host network operator, and it provides functions such as establishment and management of a neutral host network through interworking with a business support system.

The NHO node 300 provides a neutral host network service using a shared frequency band and an unlicensed band in accordance with an agreement with a mobile network operator having subscribers. In the present disclosure, the NHO node 300 may provide the neutral host network service exclusively to the mobile users or user equipments (UEs) that are subject to the neutral host network service and subscribed to a mobile network operator agreed to by using a blockchain and a smart contract.

To this end, the NHO node 300 may identify the UE of the contractual mobile network operator among the UEs located within the neutral host network coverage. On the contrary, a conventional issue has been related to the NHO node 300 otherwise having to identify a UE and perform a network connection thereto through complex and cost-inducing interworking with the authentication server of a mobile network operator. To address and terminate this issue, the present disclosure allows the NHO node 300 to identify the UE of the contractual mobile network operator among UEs located within the neutral host network coverage under the smart contract stored in the blockchain.

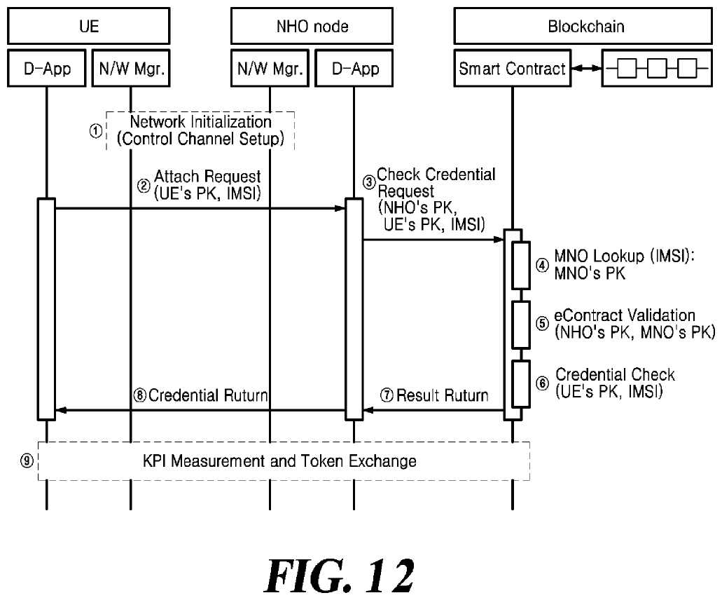

Hereinafter, with reference to FIGS. 10 and 12, a method for the NHO node 300 to identify a UE according to at least one embodiment of the present disclosure will be described.

FIG. 10 is a conceptual diagram for explaining a first method performed by the NHO node 300 for identifying the UE, according to at least one embodiment of the present disclosure.

As shown in FIG. 10, in the beginning, the UE sends the MNO node 310 a request for granting access to the neutral host network.

The MNO node 310 stores, on the blockchain, the right to access the neutral host network for the UE. At this time, the MNO node 310 preferably uses tokens purchased or mined by a mobile network operator as an access right to the neutral host network, which is nonexclusive. For example, the MNO node 310 may transmit at least one of the credential and utility tokens corresponding to an access right, to a blockchain account matching the UE according to the service provision policy.

Upon receiving an access request from the UE within the neutral host network coverage, the NHO node 300 may check whether the access right is stored on the blockchain in accord with the UE, and accordingly control the access of the UE to the neutral host network.

FIG. 12 is a flowchart for explaining a second method performed by the NHO node 300 for identifying the UE, according to at least one embodiment of the present disclosure. Meanwhile, the operation of the UE described below may be performed by the user equipment node 320 that is implemented by the DApp in the UE.

\textcircled{1} The UE performs network communication initialization and control channel setup.

\textcircled{2} The UE requests the NHO node 300 for access permission. In this case, an access permission request signal may be generated including parameters for permission confirmation, for example, the public key of the UE owner, International Mobile Subscriber Identity (IMSI), Globally Unique Temporary Identifier (GUTI), and the like.

\textcircled{3} The NHO node 300 requests to check the credential of the UE about its network service use right with the smart contract on the blockchain, and at this time, transmits the parameters provided from the UE along with the public key of the NHO node 300.

\textcircled{4} The smart contract identifies the mobile network operator by using the received parameters.

\textcircled{5}, \textcircled{6} The smart contract checks whether there is an executable network service contract identified from the smart contract between the mobile network operator and the neutral host network operator, and accordingly performs the credential check on the UE whether it has the network service use right.

\textcircled{7}, \textcircled{8} NHO node 300 is provided with a result of credential check on whether the UE is authorized to use the network service, and it accordingly transmits a credential response to the UE for the same to use the neutral host network.

\textcircled{9} After accessing the neutral host network, the UE performs KPI measurement and a token exchange-by-usage scenario.

Referring back to FIG. 3, the NHO node 300 collects service usage information from the UE that used the neutral host network service, and transmits a payment request for the usage to the MNO node 310. Meanwhile, in at least one embodiment of the present disclosure, the service usage information of the UE includes, but is not limited to, utility tokens equivalent to an amount converted in proportion to the service usage and quality of the neutral host network service.

The MNO node 310 is a blockchain network node corresponding to the mobile network operator, and it provides functions such as a management function and fee processing for the UE when using the neutral host network service.

In the present disclosure, the MNO node 310 collects service usage information of the UE, and operates based on the blockchain and smart contract for arranging the NHO node 300 to pay a fee commensurate with the service usage information to the neutral host network operator.

The MNO node 310 may be provided from the NHO node 300 with the UE's service usage information collected by the NHO node 300 from the UE. In at least one embodiment of the present disclosure, the UE's service usage information may be utility tokens equivalent to an amount converted in proportion to the service usage and quality of the neutral host network service. To this end, the MNO node 310 may purchase or generate tokens in advance, and distribute them to the UE.

MNO node 310 pays, to the NHO node 300, legal currency amounting to the utility tokens transferred from the NHO node 130 or stable coins equivalent to the legal currency amount.

The user equipment node 320 is a blockchain network node equivalent to a mobile user who uses a network service of a neutral host network operator, and it provides functions such as access to a neutral host network and transmission of service usage information.

In the present disclosure, the user equipment node 320 may receive tokens distributed in relation to the use of a neutral host network service in advance from the MNO node 310 of the mobile network operator to which the UE is subscribed.

Accordingly, the user equipment node 320 may measure the service usage and quality information by the use of the neutral host network service, and provide the NHO node 130 with utility tokens equivalent to an amount converted in proportion to the measurement as the service usage information.

The business platform 330 performs functions necessary to operate the blockchain and the blockchain network according to the definition of a service node.

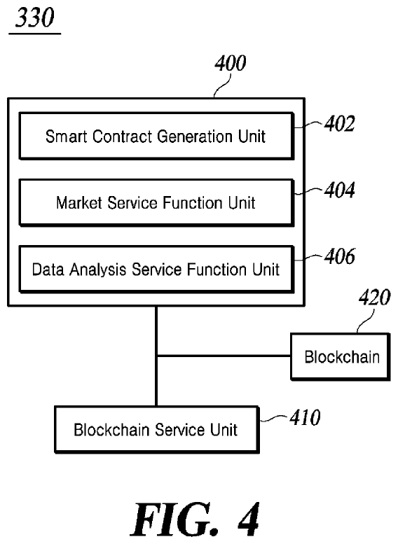

As shown in FIG. 4, the business platform 330 according to at least one embodiment of the present disclosure includes a business service unit 400, a blockchain service unit 410, and a blockchain 420.

The business service unit 400, which is a device that provides necessary services off the blockchain in relation to the neutral host network service, may include a smart contract generation unit 402, a market service function unit 404, and a data analysis service function unit 406.

The smart contract generation unit 402 functions to enable efficient contract conclusion and automatic execution between the mobile network operator and the neutral host network operator.

The smart contract generation unit 402 according to at least one embodiment of the present disclosure generates and stores on the blockchain (or distributed ledger) a smart contract related to a neutral host network service between the mobile network operator and the neutral host network operator.

As shown in FIG. 7, the smart contract generation unit 402 first utilizes a standard contract or service level agreement (SLA) expressed in natural language as a basis for arranging the mobile network operator and the neutral host network operator to adjust/agree on negotiable conditions with each other. Here, the contents and conditions of the standard contract may be implemented as an optional combination of predefined phrases or sentences specific to the business field.

The smart contract generating unit 402 converts the concluded contract content into executable software on a blockchain or blockchain network through a rule engine such as artificial intelligence (AI) to generate a smart contract (e.g. executable codes).

The smart contract generation unit 402 performs non-repudiation on the smart contract by using the respective digital signatures of the mobile network operator and the neutral host network operator, and stores the processed smart contract on the blockchain 420. This immediately guarantees the integrity of the information on the agreement concluded between the mobile network operator and the neutral host network operator.

The market service function unit 404 further provides service features including an additional service function of at least supporting the mobile network operator to have an advance review of product information on the neutral host network service, which is described by the neutral host network operator. In particular, the market service function unit 404 supports the mobile network operator to effectively read product information in advance and then proceed to the contract stage.

The data analysis service function unit 406 performs a function of visualizing and providing data related to some or all of the agreement information included in the smart contract. Meanwhile, the data analysis service function unit 406 may re-convert the code-form agreement information back into a natural language format for visualization of related data and provide the natural language agreement information.

The blockchain service unit 410 functions to automatically execute the smart contract by utilizing the blockchain 420. To this end, the blockchain service unit 410 may function to verify the integrity of neutral host network service-related events occurring off the blockchain by utilizing the blockchain 420. In the present disclosure, the blockchain service unit 410 performs functions such as securing the reliability of a transaction, providing the integrity of N/W performance data, and controlling N/W access by using a blockchain.

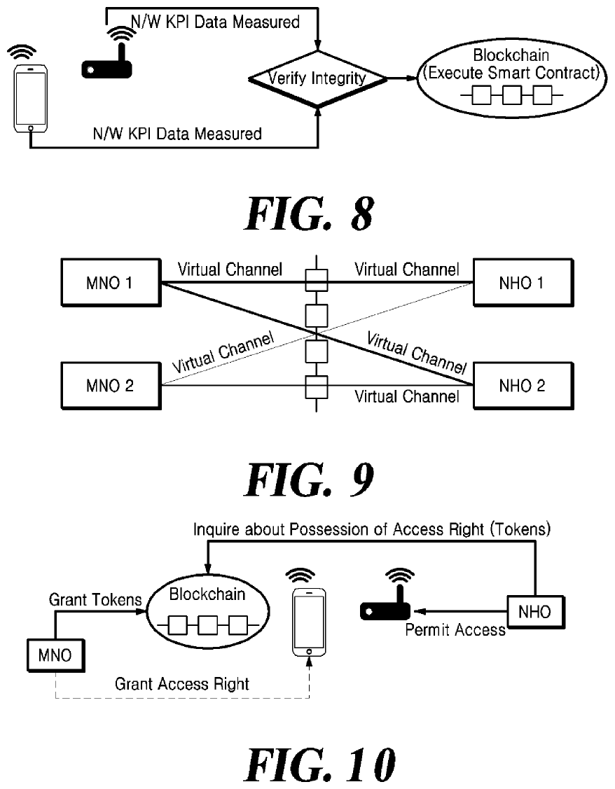

Hereinafter, the functions of the blockchain service unit 410 according to at least one embodiment of the present disclosure will be described with reference to FIGS. 8, 9, and 11 together.

The blockchain service unit 410 performs verification by comparing the service usage information measured from the UE on its usage of the neutral host network service with the service provision information measured from the NHO node 300, and stores, on the blockchain, the service usage information that completed the verification.

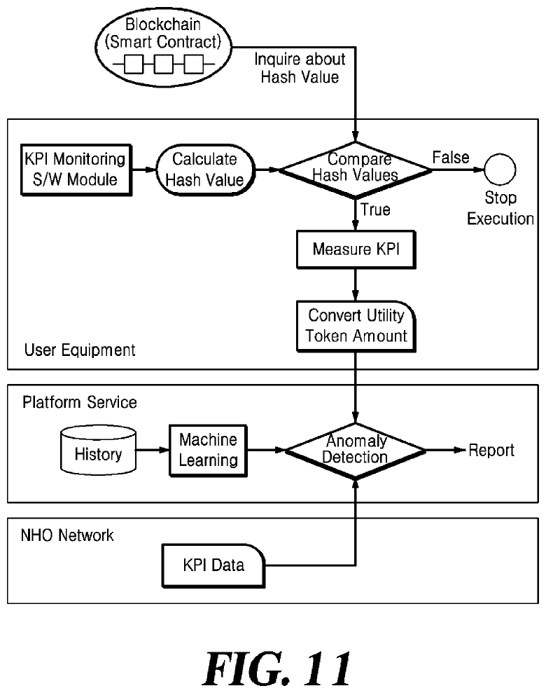

Referring to FIGS. 8 and 11, the UE first measures service usage information (e.g. KPI data) of the neutral host network service, converts the measured information into a utility token amount, and provides the utility token amount to the business platform 330.

On the other hand, for this purpose, the UE may be installed with a software program for measuring and converting the service usage information into a utility token amount. On the other hand, the present disclosure in one embodiment performs the verification of the software program first to provide the integrity of the service usage information.

In particular, the UE may calculate a hash value before installation or execution of that software program and compare the calculated hash value with the original hash value queried on the blockchain to verify integrity. For example, the UE may stop the installation or execution if the comparison result of the hash values is false. Another embodiment utilizes an asymmetric key cryptography system in place of a hash value.

The blockchain service unit 410 compares the measured KPI data for the UE from the NHO node 300 with the amount of utility token informed from the UE, and if the difference is less than a predetermined threshold, it determines that the service usage information is completely verified. On the other hand, the blockchain service unit 410 may utilize a machine learning method in the process of comparing the KPI data with the amount of utility token.

Further, as shown in FIG. 9, the blockchain service unit 410 may prevent sensitive information from being exposed due to the sharing of transaction content using the blockchain by logically isolating the transaction data collected about any one NHO node-MNO node group from being checked by other NHO node-MNO node groups or by exercising control over access rights.

The blockchain 420 refers to an electronic ledger implemented as a computer-based distributed system composed of blocks each composed of transactions. In this blockchain 420, the NHO node 300, MNO node 310, user equipment node 320, and business platform 330 may be shared in part or in full.

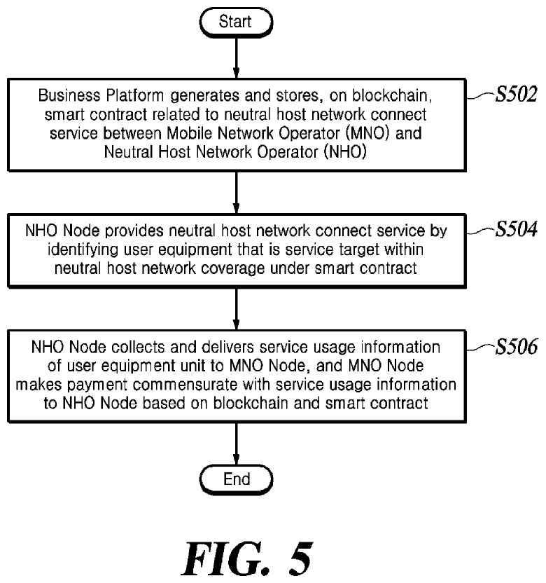

FIG. 5 is a flowchart of a method of providing a neutral host network service according to at least one embodiment of the present disclosure.

The business platform 330 generates and stores on the blockchain a smart contract related to a neutral host network connect service between a mobile network operator and a neutral host network operator (S502). In Step S502, the business platform 330 converts the contents of the contract concluded based on the standard contract or service level agreement expressed in natural language between the mobile network operator and the neutral host network operator into a software format executable on the blockchain or blockchain network and thereby generates the smart contract.

The NHO node 300 provides a neutral host network service by identifying the UE that is the service target within the neutral host network coverage under the smart contract of Step S502 (S504). In Step S504, upon receiving an access request from the UE within the neutral host network coverage, the NHO node 300 may check whether the access right is stored on the blockchain in concert with the UE, and accordingly identify the UE.

In another embodiment, the NHO node 300 identifies the UE by confirming the existence of an executable network connect service contract between the UE and the NHO node 300 through the smart contract.

The MNO node 310 collects service usage information for the UE from the NHO node 300, and makes payment commensurate with the service usage information to the NHO node 300 based on the blockchain and smart contract (S506). In Step S506, the MNO node 310 is provided with utility tokens as service usage information of the UE, and pays the NHO node 300 with legal currency corresponding to the utility tokens or stable coins equivalent to the legal currency.

Here, since Steps S502 and S504 correspond to the operations of the respective components of the above-described neutral host network service system, a further detailed description will be omitted.

Although the steps in FIG. 5 are described to be sequentially performed, they merely instantiate the technical idea of some embodiments of the present disclosure. Therefore, a person having ordinary skill in the pertinent art could perform the steps by changing the sequences described in FIG. 5 or by performing two or more of the steps in parallel, and hence the steps in FIG. 5 are not limited to the illustrated chronological sequences.

As described above, the method of providing a service by the neutral host network service system described in FIG. 5 may be implemented as a program and recorded to be computer-readable on a recording medium (CD-ROM, RAM, ROM, memory card, hard disk, optical/magnetic disk, storage devices, and the like) by way of computer software.

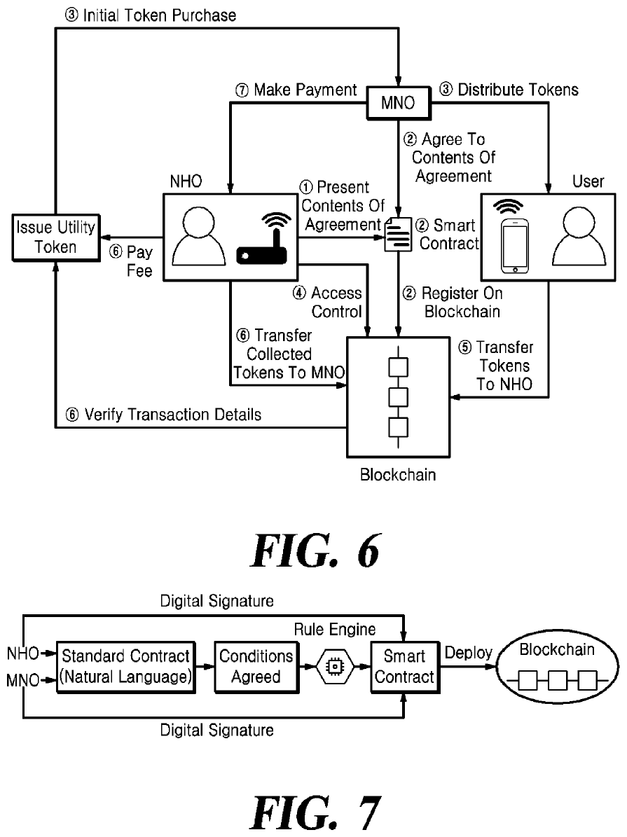

FIG. 6 is a diagram illustrating a neutral host network service provision scenario according to at least one embodiment of the present disclosure.

As shown in FIG. 6, the neutral host network service provision scenario according to at least one embodiment of the present disclosure is composed of steps \textcircled{1} to \textcircled{7}.

\textcircled{1} The neutral host network operator presents the contract contents and conditions such as rate, settlement method, SLA, etc. in relation to its neutral host network service through the business platform 330.

\textcircled{2} When the mobile network operator agrees to the contract contents presented, the business platform 330 stores the contract contents as a smart contract on the blockchain and automatically executes the smart contract contents.

\textcircled{3} The MNO node 310 purchases and distributes utility tokens to the UE.

\textcircled{4} The NHO node 300 identifies the UE that is the service target by checking the IMSI of the UE existing within the neutral host network coverage and provides an access service.

\textcircled{5} The UE automatically transmits the calculated amount of utility tokens to the NHO node 300 according to service usage and quality.

\textcircled{6} The NHO node 300 delivers the utility tokens collected for a certain period to the MNO node 310, and the platform provider verifies the utility tokens and then generates a block and proceeds with token issuance and fee receipt.

\textcircled{7} The MNO node 310 pays the NHO node 300 with legal currency or stable coins fixed to legal currency equivalent to the amount of token transferred by the NHO node 300 under the smart contract.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

### REFERENCE NUMERALS

| | |
|---|---|
| 300: NHO node | 310: MNO node |
| 320: user equipment node | 330: business platform |
| 400: business service unit | 402: smart contract generation |
| 404: market service function unit | 406: data analysis service function |
| 410: blockchain service unit | |

### CROSS-REFERENCE TO RELATED APPLICATION

This application claims priority under 35 U.S.C § 119(a) of Patent Application No. 10-2019-0002204, filed on Jan. 8, 2019 and Patent Application No. 10-2019-0054130, filed on May 9, 2019 in Korea, the entire contents of which are incorporated herein by reference. Additionally, this non-provisional application claims priority in countries, other than the U.S., with the same reason based on the Korean patent application, the entire content of which is hereby incorporated by reference.

1. A neutral host network service system, comprising:
a business platform configured to generate and store on a blockchain a smart contract related to a neutral host network service between a mobile network operator (MNO) and a neutral host network operator (NHO), and to operates as a service node that verifies integrity of data generated outside the blockchain in connection with the neutral host network service and stores the verified data on the blockchain for causing the smart contract to be automatically;
an NHO node configured to identify a user equipment (UE) subject to the neutral host network service under the smart contract, to provide the UE with the neutral host network service, and to collect service usage information on the neutral host network service as used by the UE; and
an MNO node configured to pay a fee commensurate with the service usage information to the NHO node based on the blockchain and the smart contract.

2. The neutral host network service system of claim 1, wherein the business platform is configured to generate the smart contract by converting contents of a contract concluded based on a standard contract or service level agreement (SLA) expressed in natural language between the mobile network operator and the neutral host network operator into software executable on a blockchain or blockchain network.

3. The neutral host network service system of claim 2, wherein the business platform is configured to perform an integrity check and non-repudiation of the smart contract by using digital signatures of the mobile network operator and the neutral host network operator, respectively.

4. The neutral host network service system of claim 1, wherein the business platform is configured to further provide at least one of service features comprising:
an additional service function including supporting the mobile network operator to have an advance viewing of a product information on the neutral host network service, which is described by the neutral host network operator; and
a data analysis service function for visualizing and providing data related to some or all of contract contents included in the smart contract.

5. The neutral host network service system of claim 1, wherein the business platform is configured to compare the service usage information measured by the UE with a service provision information measured by the NHO node to verifies integrity of the data, and to cause the smart contract to be executed by storing the service usage information that completed the verification on the blockchain or by registering only a result of the verification with the blockchain.

6. The neutral host network service system of claim 5, wherein the service usage information of the UE comprises:
utility tokens equivalent to an amount converted in proportion to service usage and quality of the neutral host network service.

7. The neutral host network service system of claim 1, wherein the NHO node is configured to identify, among UEs existing in a neutral host network coverage, whether a UE is subject to the neutral host network service based on the smart contract.

8. The neutral host network service system of claim 7, wherein the MNO node is configured to register on the blockchain an access right to the neutral host network matching the UE under the smart contract, and
wherein the NHO node identifies the UE by checking whether the access right corresponding to the UE is registered on the blockchain.

9. The neutral host network service system of claim 8, wherein the MNO node is configured to transmit, according to a service provision policy, at least one of a credential and utility tokens both corresponding to the access right to a blockchain account matching the UE.

10. The neutral host network service system of claim 1, wherein the service usage information of the UE comprises:
utility tokens equivalent to an amount converted in proportion to service usage and quality of the neutral host network service, and
wherein the MNO node is configured to be provided, from the MNO node, with the utility tokens collected by the MNO node from the UE for a predetermined period.

11. The neutral host network service system of claim 10, wherein the utility tokens are purchased or generated by the MNO and pre-distributed to the UE.

12. The neutral host network service system of claim 10, wherein the MNO node is configured to pay an amount of legal currency equivalent to the utility tokens or stable coins equivalent to the legal currency to the NHO node.

13. A business platform that functions as a service node of a blockchain network related to a neutral host network service, the business platform comprising:
a business service unit configured to generate and store on a blockchain a smart contract related to the neutral host network service between a mobile network operator (MNO) and a neutral host network operator (NHO); and
a blockchain service unit configured to verify integrity of data generated outside the blockchain in connection with the neutral host network service and stores the verified data on the blockchain for causing the smart contract to be automatically executed in relation to usage of the neutral host network service by a user equipment (UE) subject to the neutral host network service.

14. A method performed by a neutral host network service system for providing a service, the method comprising:
generating and storing, by a business platform which operates as a service node of a blockchain network related to a neutral host network service, on a blockchain a smart contract related to a neutral host network service between a mobile network operator (MNO) and a neutral host network operator (NHO);
identifying, by an NHO node, a user equipment (UE) existing in a neutral host network coverage and subject to the neutral host network service under the smart contract and providing the UE with the neutral host network service; and
collecting, by the NHO node, service usage information on the neutral host network service as used by the UE, delivering the service usage information to an MNO node, and paying, by the MNO node, a fee commensurate with the service usage information to the NHO node based on the blockchain and the smart contract;
wherein the business platform verifies integrity of data generated outside the blockchain in connection with the neutral host network service and stores the verified data on the blockchain for causing the smart contract to be automatically executed.

15. (canceled)
